(19) United States
(12) Patent Application Publication
(10) Pub. No.: US 2024/0162548 A1
(43) Pub. Date: May 16, 2024

(54) MOTOR VEHICLE WITH A HIGH VOLTAGE BATTERY

(71) Applicant: MAGNA STEYR Fahrzeugtechnik GmbH & Co KG, Graz (AT)

(72) Inventors: Manuel ERLACHER, Radenthein (AT); Bernhard HOFER, Graz (AT); Werner SCHWARZL, Lassnitzhoehe (AT); Bernadette SATTELKOW, Graz (AT)

(73) Assignee: MAGNA STEYR Fahrzeugtechnik GmbH & Co KG, Graz (AT)

(21) Appl. No.: 18/490,899

(22) Filed: Oct. 20, 2023

(30) Foreign Application Priority Data
Nov. 16, 2022 (EP) 22207763.8

(51) Int. Cl. H01M 50/249; B60L 50/64; B60L 58/26; H01M 10/613; H01M 10/625

(52) U.S. Cl. CPC H01M 50/249; B60L 50/64; B60L 58/26; H01M 10/613; H01M 10/625; H01M 2220/20

(57) ABSTRACT

A motor vehicle includes a high-voltage battery that includes a frame which delimits the high-voltage battery laterally, a plurality of battery cells mounted in the frame so as to be suspended in a manner such that electrical contacts of the battery cells are directed in a downwards orientation and the cell bases are directed in an upward orientation; and a floor panel that forms a cover of the high-voltage battery to cover the frame at its top side. The battery cells, in an installed position in the motor vehicle, are spatially oriented so as to be “upside down” in a manner such that the electric contacts of the battery cells point downwards, and thus, towards the driving surface/road, and the cell bases are formed at the top of the battery cells.

### CROSS-REFERENCE TO RELATED APPLICATIONS

The present application claims priority 35 U.S.C. § 119 to European Patent Publication No. EP 22207763.8 (filed on Nov. 16, 2022), which is hereby incorporated by reference in its entirety.

### TECHNICAL FIELD

One or more embodiments relate to a motor vehicle having a high-voltage battery, and a method for mounting a high-voltage battery in a motor vehicle.

### BACKGROUND

It is known that closed high-voltage batteries may be installed in motor vehicles, in particular, as a drive battery for providing electrical energy for driving the motor vehicle. The battery then has a closed battery box or a closed battery housing, which accommodates the cell modules. Such a high-voltage battery is fastened on the vehicle via screws. Beside the screw points here, a gap of at least several millimetres is typically present between the battery and the vehicle structure to avoid rubbing during operation (noises, corrosion, etc.), and also to enable collision-free mounting. For maintenance or repair purposes, the entire battery unit must be removed from the vehicle.

In the installed position, battery cells typically have electrical contacts at their top end for tapping the voltage and a cell base at their bottom end. By way of example, battery cells which are damaged in the event of an accident may then outgas upwards via the electrical contacts, in the direction of the vehicle interior, and generate heat therein.

### SUMMARY

One or more embodiments are to provide an enhanced motor vehicle having a high-voltage battery, which avoids the problems described hereinabove, has a low spatial requirement, and contributes to improved vehicle safety. One or more embodiments are also to provide a simple and cost-effective method for mounting a high-voltage battery in such a motor vehicle.

In accordance with one or more embodiments, a motor vehicle comprises: a high-voltage battery that itself comprises a frame, i.e., a battery frame which delimits the high-voltage battery laterally; a plurality of battery cells mounted in the frame so as to be suspended in a manner such that electrical contacts of the battery cells are directed in a downwards orientation and the cell bases are directed in an upward orientation; and a floor panel that forms a cover of the high-voltage battery to cover the frame at its top side.

In accordance with one or more embodiments, a high-voltage battery having suspended cells is integrated in a motor vehicle. The cells, in an installed position in the motor vehicle, are spatially oriented so as to be “upside down.” Meaning, the electric contacts of the battery cells point downwards, and thus, towards the driving surface/road, and the cell bases are formed at the top of the battery cells. Should the situation arise, outgassing of the cells takes place in the region of the now downwardly-directed cell contacts, i.e., downwards. Heat which is possibly generated is now directed towards the underride guard/vehicle exterior and not, as otherwise typical, in the direction of the vehicle interior.

Also, in contrast to the conventional design, the high-voltage battery does not have its own cover, but is sealed by its frame lying directly against the floor panel of the motor vehicle, which is preferably designed to be flat. A substantial advantage of this solution is the gain in space in the Z-direction around the air gap which must typically be observed between the battery cover and floor panel and is omitted here. Dispensing with a battery cover furthermore has cost- and weight-related advantages.

In accordance with one or more embodiments, an underride guard plate preferably forms the base of the high-voltage battery, which covers the frame at its bottom side. Accessibility to the battery cells may be ensured from below, via a preferably removable plate which simultaneously serves as an underride guard.

In accordance with one or more embodiments, a plurality of crossmembers of the supporting structure of the motor vehicle are preferably arranged within the frame of the high-voltage battery. The crossmembers are preferably welded to the frame at the axial ends of the crossmembers. The crossmembers therefore preferably form a welded structure with the battery frame.

In accordance with one or more embodiments, the battery cells are preferably each mounted on the crossmembers such that they are “suspended” in the clearances between the crossmembers so that multiple parallel rows of battery cells extend between the crossmembers.

In accordance with one or more embodiments, the battery cells may be mounted individually in the frame or mounted in the frame in groups to form battery cell modules. The high-voltage battery may therefore comprise battery modules mounted in a suspended manner.

In accordance with one or more embodiments, the frame of the high-voltage battery is preferably sealed towards the floor panel by a removable seal, in particular a mounting seal.

In accordance with one or more embodiments, at least one flat cooling element, in particular, at least one cooling plate, and/or at least one flat fire-protection element is preferably arranged at the top side of the battery cells, between battery cells and floor panel. The cooling element(s) and the fire protection element(s) may be inserted above the cells and fixed in place.

In accordance with one or more embodiments, a method for mounting a high-voltage battery in a motor vehicle, and thus, for producing a motor vehicle as described hereinabove, may provide for at least one flat cooling element, i.e., a cooling plate, to be installed in the frame, preferably from below, in a pre-mounting process, for the battery cells to then be mounted in the frame, and for the underride guard plate to be mounted on the frame from below. The crossmembers may likewise be mounted in the frame before the underride guard plate, after, or preferably before, mounting the cooling plate.

In accordance with one or more embodiments, the crossmembers may also form an element of the battery frame structure. The frame and crossmembers may therefore form a pre-mounted unit. It is also possible for the crossmembers and the cooling plate or cooling plates to form a pre-mounted unit. These components, the pre-mounted unit, may be held in the frame and/or mounted on the frame together, with or without battery cells/modules.

In accordance with one or more embodiments, the pre-assembly of the battery housing takes place in the removed state and the housing, the frame, is accessible from both sides. The cooling plate is preferably firstly installed from below and fixed in place. This is followed by the battery cells, which may then be electrically connected to one another. The closing plate, which is simultaneously designed as an underride guard, is finally added from below.

In accordance with one or more embodiments, the pre-mounted battery, fitted with a protective cover, may be brought to an assembly line and installed in the vehicle from below via typical manipulation devices.

In accordance with one or more embodiments, the pre-mounted high-voltage battery may be mounted in a remaining supporting structure of the motor vehicle from below, preferably fastened on side sills of the motor vehicle, for example via a screw connection.

### DRAWINGS

One or more embodiments will be illustrated by way of example in the drawings and explained in the description hereinbelow.

FIG. 1 illustrates a three-dimensional schematic illustration of a high-voltage battery in a frame of a motor vehicle, in sections X-X and Y-Y, in accordance with one or more embodiments.

FIG. 2 illustrates a sectional view of a sub-region of the motor vehicle of section X-X of FIG. 1, which motor vehicle does not belong to the disclosure.

FIG. 3 illustrates is a sectional view of a sub-region of a motor vehicle in a first embodiment of section X-X of FIG. 1.

FIG. 4 illustrates a sectional view of a sub-region of the motor vehicle in the first embodiment of section Y-Y of FIG. 1.

FIG. 5 illustrates a sectional view of a sub-region of a motor vehicle in a second embodiment of section X-X of FIG. 1.

FIG. 6 illustrates a sectional view of a sub-region of a motor vehicle in the second embodiment of section Y-Y of FIG. 1.

### DESCRIPTION

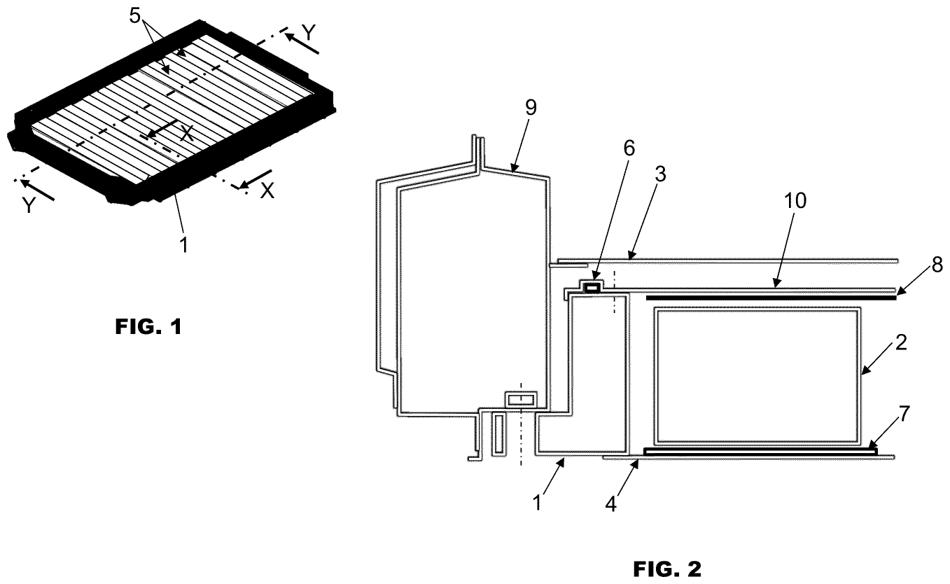

FIG. 1 is a schematic illustration of a high-voltage battery in a frame of a motor vehicle and shows the position of the sections X-X and Y-Y, which are used in the following FIGS. 2 to 6.

FIG. 2 represents a motor vehicle which does not belong to the disclosure. The motor vehicle comprises a high-voltage battery, which itself comprises battery cells 2, which are arranged in a frame 1 which delimits the high-voltage battery laterally. The high-voltage battery here is delimited at the top by a battery cover 10. An air gap is located between the battery cover 10 and a floor panel 3 of the motor vehicle. The battery cover 10 is sealed towards the frame 1 via a seal 6. At the bottom side of the high-voltage battery, an underride guard plate 4 forms the base of the high-voltage battery. The battery cover 10 and the underride guard plate 4 therefore cover the frame 1 so that, together, they form the housing of the high-voltage battery.

The battery cells 2 are typically arranged in an “upright” orientation in the housing, so that electrical contacts of the battery cells 2 are arranged at the top of the battery cells 2. At the top side of the high-voltage battery, a fire protection element 8 is therefore arranged between battery cells 2 and battery cover 10. A cooling element 7 is arranged at the bottom side of the high-voltage battery, between battery cells 2 and underride guard plate 4. The high-voltage battery is fastened laterally on a sill 9.

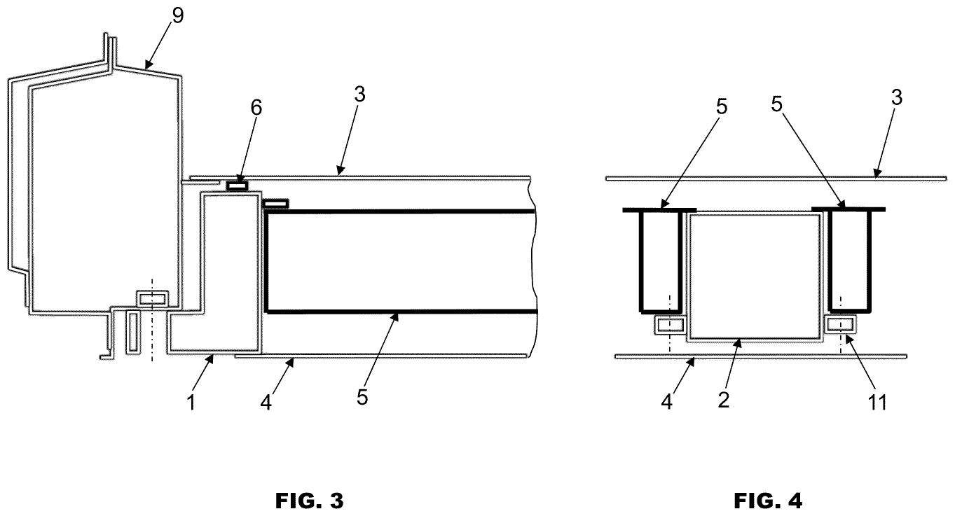

A motor vehicle in accordance with one or more embodiments is illustrated in FIGS. 3 and 4. A floor plate 3 of the motor vehicle forms the battery cover of the high-voltage battery here, and therefore, a cover of the high-voltage battery, which covers the frame 1 at its top side. The battery cells 2 are mounted in the frame 1 in a “suspended” manner, so that the electrical contacts of the battery cells 2 are directed in a downward orientation (i.e., towards the driving surface) and the cell bases are directed in an upward orientation. An underride guard plate 4 forms the base of the high-voltage battery, which covers the frame 1 at its bottom side.

As is also illustrated in FIG. 1, in the embodiment of FIGS. 3 and 4, a plurality of crossmembers 5 of the supporting structure of the motor vehicle are arranged parallel to one another within the frame 1 of the high-voltage battery. The crossmembers 5 are welded to the frame 1 at the ends of the crossmembers 5. The battery cells 2 are each mounted on the crossmembers 5 such that they are “suspended” in the clearances between the crossmembers 5, so that multiple parallel rows of battery cells 2 extend between the crossmembers 5. The frame 1 of the high-voltage battery is sealed towards the floor plate 3 by a removable seal 6, namely a mounting seal. In the region of the bottom ends of the battery cells 2, these are screwed to the crossmembers 5 from below, preferably screwed to the bottom sides of the crossmembers 5, via a screw connection 11.

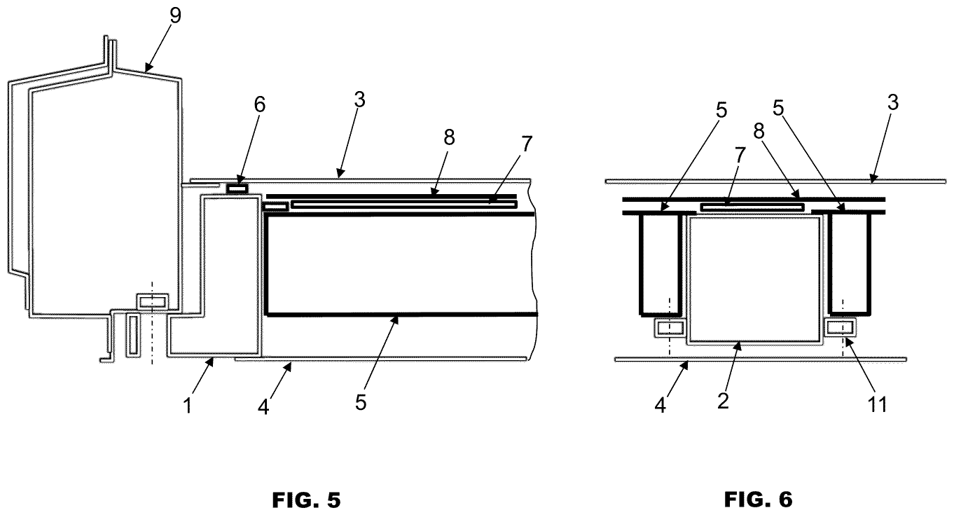

As illustrated in the embodiment of the motor vehicle according to FIGS. 5 and 6, at least one flat cooling element 7, in particular, a cooling plate, and/or at least one flat fire protection element 8 may each be arranged at the top side of the battery cells 2, between battery cells 2 and floor panel 3.

The terms “coupled,” “attached,” or “connected” may be used herein to refer to any type of relationship, direct or indirect, between the components in question, and may apply to electrical, mechanical, fluid, thermal, optical, electromagnetic, electromechanical, or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 Frame
2 Battery cells
3 Floor panel
4 Underride guard plate
5 Crossmember
6 Seal
7 Cooling element
9 Fire protection element
9 Sill
10 Battery cover
11 Screw connection

What is claimed is:

1. A motor vehicle, comprising:
a high-voltage battery that includes:
a frame which laterally delimits the high-voltage battery, and
a plurality of battery cells mounted in the frame so as to be suspended in a manner such that electrical contacts of the battery cells are directed in a downward orientation towards a driving surface and the cell bases are directed in an upward orientation, and
a floor panel that forms a cover of the high-voltage battery to cover a top side of the frame.

2. The motor vehicle of claim 1, further comprising an underride guard plate that forms a base of the high-voltage battery and covers a bottom side of the frame.

3. The motor vehicle of claim 1, further comprising a plurality of crossmembers of a supporting structure of the motor vehicle, the plurality of crossmembers being arranged within and connected to the frame of the high-voltage battery.

4. The motor vehicle of claim 3, wherein the plurality of crossmembers are welded to the frame at ends thereof.

5. The motor vehicle of claim 3, wherein each battery cell in the plurality of battery cells are mounted on the crossmembers so as to be suspended in clearances between adjacent crossmembers.

6. The motor vehicle of claim 5, wherein each battery cell in the plurality of battery cells are mounted on the crossmembers in a manner such that multiple parallel rows of battery cells extend between the crossmembers.

7. The motor vehicle of claim 1, wherein the battery cells are mounted individually in the frame.

8. The motor vehicle of claim 1, wherein the battery cells are mounted in the frame in groups to form battery cell modules.

9. The motor vehicle of claim 1, further comprising a removeable seal to seal the frame towards the floor panel.

10. The motor vehicle of claim 1, further comprising at least one flat cooling element and/or at least one flat fire protection element arranged at a top side of the battery cells, between the battery cells and the floor panel.

11. A method for mounting the high-voltage battery of claim 1 in a motor vehicle, the method comprising:
installing, in a pre-mounting process, at least one flat cooling element in the frame from below;
mounting the plurality of battery cells in the frame;
covering the high-voltage battery via the floor panel which also covers the top side of the frame; and
mounting an underride guard plate on the frame from below.

12. The method of claim 8, further comprising fastening the high-voltage battery, after pre-mounting the high-voltage battery in a remaining supporting structure of the motor vehicle from below, on side sills of the motor vehicle.
